(19) United States
(12) Patent Application Publication
(10) Pub. No.: US 2008/0151302 A1
(43) Pub. Date: Jun. 26, 2008

(54) IMAGE FORMING APPARATUS AND METHOD OF CONTROLLING THE SAME

(75) Inventor: Jae In LEE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/952,444

(22) Filed: Dec. 7, 2007

(30) Foreign Application Priority Data
Dec. 7, 2006 (KR) 2006-123938
Nov. 21, 2007 (KR) 2007-119225

(51) Int. Cl. G06F 15/00

(52) U.S. Cl. 358/1.16; 358/1.15

(57) ABSTRACT

An image forming apparatus capable of shortening a printing time and providing convenience to a user and a method of controlling the same. The method includes scanning identification information of a document which identifies the document, determining whether the scanned identification information of the document is stored in a memory unit, and extracting document data corresponding to the identification information from the memory unit and printing the document data, according to whether the scanned identification information of the document is stored in the memory unit.

### CROSS-REFERENCE TO RELATED APPLICATION

This application claims the benefit of Korean Patent Application No. 2006-123938, filed on Dec. 7, 2006 and No. 2007-119225, filed on Nov. 21, 2007 in the Korean Intellectual Property Office, the disclosure of which is incorporated herein by reference.

### BACKGROUND OF THE INVENTION

1. Field of the Invention

Aspects of the present Invention relate to an Image forming apparatus and a method of controlling the same, and, more particularly, to an image forming apparatus capable of shortening a printing time by checking whether a document to be printed is stored, and a method of controlling the same.

2. Description of the Related Art

Generally, an image forming apparatus, such as a printer, a copier, a multi-functional machine, etc., is used to print various kinds of printed materials (hereinafter, referred to as documents), such as a book, a report or a paper, onto printing media such as sheets of paper, transparency sheets, stationary, etc. The image forming apparatus scans data of a document to be printed using a scan unit and prints the scanned document data using a printing unit.

Recently, manufacturers have begun mounting various units (e.g., a display unit, a memory unit and so on) in image forming apparatuses so as to provide various convenient functions for a user (e.g., storing of a document in the memory unit or re-printing of a document which was printed in the past).

However, when a lengthy document such as a book is printed, it is troublesome that the user should individually turn the pages of the book in order to print desired pages. Although a document to be printed may already be previously stored, the user still needs to manually search the documents stored in the memory unit to identify the document. When a great amount of data is stored in the memory, the searching of the stored data is time-consuming and labor-intensive.

### SUMMARY OF THE INVENTION

Therefore, it is an aspect of the present invention to provide an image forming apparatus capable of shortening a printing time by checking whether data of a document to be printed is stored in a memory unit and printing stored document data if the document data is stored, and a method of controlling the same.

It is another aspect of the present invention to provide an image forming apparatus capable of providing convenience to a user by scanning identification information of a document to be printed and automatically checking whether the document is stored in a memory unit, and a method of controlling the same.

Additional aspects and/or advantages of the invention will be set forth in part in the description which follows and, in part, will be obvious from the description, or may be learned by practice of the invention.

The above and/or other aspects and advantages can be achieved by a method of controlling an image forming apparatus, including scanning identification information of a document which identifies the document; determining whether the scanned identification information of the document is stored in a memory unit; and extracting document data corresponding to the identification information from the memory unit and printing the document data, according to whether the scanned identification information of the document is stored in the memory unit.

According to an aspect, the identification information of the document is an international standard book number (ISBN) barcode of the document.

According to an aspect, plural pieces of the identification information and the corresponding document data are stored in the memory unit.

According to an aspect, the document data includes page numbers of the document.

According to an aspect, the document data includes document information corresponding to the page numbers.

According to an aspect, the method further includes inputting a desired page of the document in the page numbers of the document data, and the printing of the document data may include printing document information corresponding to the inputted page.

According to an aspect, the method further includes indicating whether the scanned identification information of the document is stored in the memory unit.

According to an aspect, the method further includes scanning the document data corresponding to the identification information and storing the document data in the memory unit if the scanned identification information of the document is not stored in the memory unit.

According to an aspect, the storing of the document data includes storing the document data when the document is printed according to whether a user inputs a document storage command.

In accordance with another aspect of the invention, an image forming apparatus includes a memory unit to store identification information of a document and document data corresponding to the identification information, a scan unit to scan identification information of a document to be printed; a printing unit to print document data of the document to be printed; and a control unit to determine whether the scanned identification information of the document is stored in the memory unit and to control the printing unit to extract and print the document data corresponding to the identification information stored in the memory unit according to whether the scanned identification information of the document to be printed corresponds to the identification information stored in the memory unit.

According to another aspect, the document data of the document corresponding to the identification information stored in the memory unit includes page numbers of the document and document information corresponding to the page numbers.

According to another aspect, the control unit indicates whether the scanned identification information of the document is stored in the memory unit.

According to another aspect, the control unit controls the scan unit to scan the document data of the document to be printed if the scanned identification information of the document is not stored in the memory unit and controls the memory unit to store the scanned document data in the memory unit.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a control block diagram showing an image forming apparatus according to an embodiment of the present invention;

FIG. 2 is a view showing the configuration of an operation panel shown in FIG. 1 when scanned identification information of a document is stored;

FIG. 3 is a view showing the configuration of the operation panel shown in FIG. 1 when page numbers of a scanned document are inputted; and

FIG. 4 is a flowchart illustrating a method to control the image forming apparatus according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

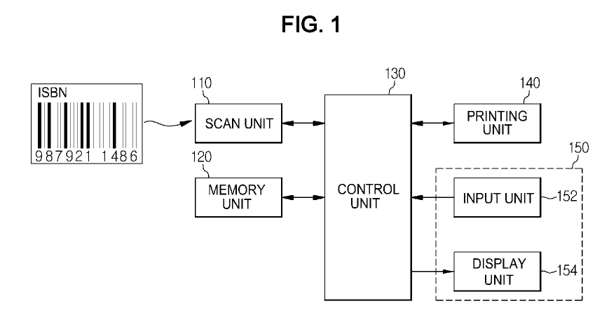

FIG. 1 is a control block diagram showing an image forming apparatus 100 according to an embodiment of the present invention. The image forming apparatus 100 includes a scan unit 110, a memory unit 120, a control unit 130, a printing unit 140 and an operation panel 150.

The scan unit 110 scans identification information of a document (e.g., a book, an article, etc.) to be printed and the content of the document (e.g., words and page numbers of the document).

The identification information of the document indicates information used to identify the document to be printed (e.g., a title, a publication date, a publisher and country information of the document). According to an aspect of the present invention, the identification information includes an international standard book number (ISBN) barcode attached to a front side or a rear side of a book. It is understood that the identification information is not limited to being an ISBN barcode, and may instead be another type of label, such as an International Standard Serial Number (ISSN).

The ISBN is a unique number which is given to every book produced in the world according to an international standard method. That is, the ISBN may be used with an international registration system to identify books.

According to an aspect of the present invention, the ISBN barcode includes a 10-digit number, which is divided into four groups including a country number, a publisher number, a title identification number and a check digit. In addition, the ISBN further includes an additional five-digit number, which is attached next to the ISBN and includes a one-digit reader target number, a one-digit publication form number and a three-digit content classification number. However, it is understood that the ISBN is not limited to being a 10-digit number, and may instead be a different length, such as a 13-digit number.

Accordingly, the purpose of the ISBN is to unify information management and accomplish computerization to improve distribution of books in the publication business. The ISBN is convenient for many reasons, such as for example, because the ISBN can easily be used internationally or with administrative work in a library, unlike a conventional code.

When a document to be printed is a book, the identification information of the document is the ISBN barcode. Accordingly, the scan unit 110 performs a function of a barcode reader to read the ISBN barcode or a function of a barcode sensor to sense the ISBN barcode.

Although the scan unit 110 may be embodied as a barcode reader or sensor to read or scan the ISBN barcode and read the identification information of the document, aspects of the present invention are not limited to the scan unit 110 being embodied as such. For example, the scan unit 110 may instead use optical character recognition (OCR) to scan the ISBN barcode and read ISBN barcode information, achieving the same beneficial effects. Furthermore, the identification information may be input to the control unit 130 in other ways as well, for example, the ISBN barcode numbers may be typed into the control unit 130.

The memory unit 120 is a storage medium to store the identification information of the document and the data of the document corresponding to the identification information. The data stored in the memory unit 120 may be data of all the documents printed by the printing unit 140, data selected as document data which is desired to be stored by the user, document data transmitted from an external device (e.g., a server), or data otherwise selected to be stored. The memory unit 120 may be, for example, a DRAM, an SDRAM, an RDRAM, a DDRAM, or an SRAM.

The document data includes document information related to the contents of the document, such as the contents of a book, a report or a paper, the page numbers of the document, and so on. According to an aspect, the document information corresponds to different pages of the document.

The control unit 130 controls the overall operations of the image forming apparatus. That is, the control unit 130 controls the scan unit 110 to perform a scan operation to read the identification information of the document, determines whether the scanned identification information is stored in the memory unit 120, and controls the printing data 140 to extract and print the document data corresponding to the scanned identification information from the memory unit 120 if the identification information is stored in the memory unit 120. If the scanned identification information is not stored in the memory unit 120, the control unit 130 allows the user to select whether the printed document data should be stored at the time of printing the document, and if so, stores the printed document data in the memory unit 120.

The printing unit 140 prints the scanned document data or the document data extracted from the memory unit 120 on a printing medium according to a control signal of the control unit 130. The printing unit 140 may be various types, such as, for example, a laser printer, an inkjet printer, etc.

The operation panel 150 includes an input unit 152 and a display unit 154. The operations panel 150 sends a user command inputted through the input unit 152 to the control unit 130, and displays an operation state of the image forming apparatus on the display unit 154 according to the control signal of the control unit 130.

The display unit 154 is used to display the document data. The display unit 154 may be various types, such as, for example, a liquid crystal display (LCD), a plasma display panel (PDP), a thin-film transistor (TFT) display, an organic electroluminescence display, and a cathode ray tube (CRT). According to an aspect of the present invention, the display unit 154 displays the document data (e.g., the page numbers of the document) corresponding to the scanned identification information on the screen.

The input unit 152 includes a plurality of buttons to set functions provided by the image forming apparatus 100. For example, the input unit 152 allows the user to input the page numbers of the document which the user desires to print.

In more detail, when the user wants to print a book, for example, “Pride and Prejudice,” the ISBN barcode attached to the front side or the rear side of the book “Pride and Prejudice” is scanned using the scan unit 110. The control unit 130 determines whether the scanned ISBN barcode information, that is, the identification information of the document, is stored in the memory unit 120. If so, the control unit 130 extracts the document data corresponding to the identification information stored in the memory unit 120, and displays the page numbers of the document data on the display unit 154. Thereafter, when the user inputs the page numbers of the document to be printed through the input unit 152, the control unit 130 prints the content of the document data corresponding to the inputted page numbers using the printing unit 140.

That is, when the user wants to print the book “Pride and Prejudice,” the ISBN barcode attached to the book “Pride and Prejudice,” i.e., the identification information of the document, is scanned. Then, the control unit 130 determines whether the scanned identification information is stored in the memory unit 120. If the control unit 130 determines that the scanned identification information is stored in the memory unit 120, the document data of the book “Pride and Prejudice” is extracted from the memory unit 120, and printed without requiring the user to separately perform the function of printing the document data.

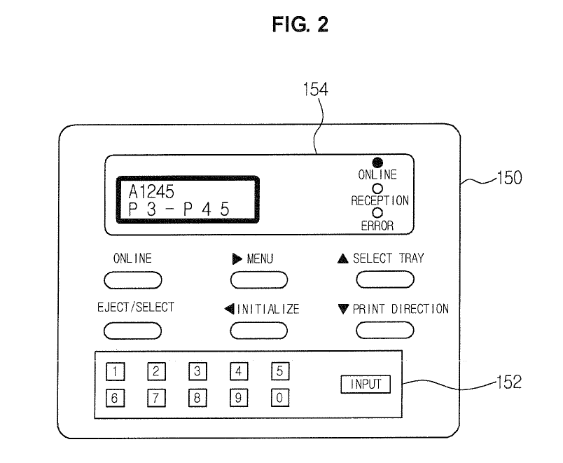

FIG. 2 is a view showing the configuration of the operation panel 150 shown in FIG. 1 when the identification information of the document scanned by the scan unit 110 is stored in the memory unit 120. In FIG. 2, when the identification information (e.g., the ISBN barcode) of the document is scanned by the scan unit 110, the scanned identification information A1245 of the document and the document data (the page numbers of the document represented by P3-P45) corresponding to the identification information are extracted from the memory unit 120 and are displayed on the display unit 154. Accordingly, the user inputs the page numbers of the document to be printed in the page numbers of the document displayed on the display unit 154 through the input unit 152.

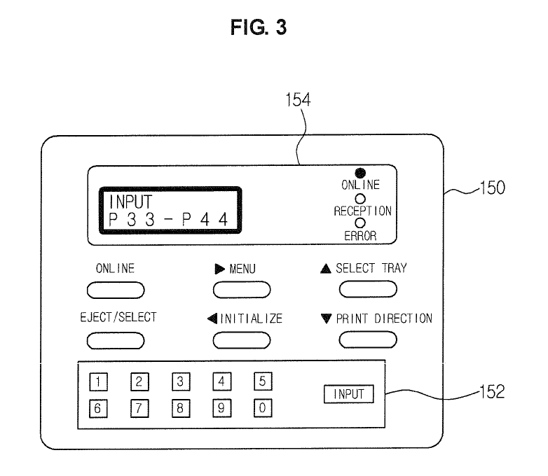

FIG. 3 is a view showing the configuration of the operation panel 150 shown in FIG. 1 when the user inputs the page numbers of the document through the input unit 152. FIG. 3 shows a state in which the user inputs the page numbers of the document such that the document data (document information) corresponding to the scanned identification information (A1245) of the document is printed from page 33 to page 44.

The operation panel 150 allows the user to input the page numbers of the document to be printed through the input unit 152. The control unit 130 controls the printing unit 140 to extract the document data (document information) corresponding to the inputted page numbers from the memory unit 120 and print the document data corresponding to the page numbers. The operation panel 150 may be a touch screen, a keypad, a combination touch screen and keypad, etc.

If the scanned identification information of the document is not stored in the memory unit 120, the control unit 130 informs the user that the document corresponding to the identification information is not stored in the memory unit 120. A method of informing the user may be realized by displaying characters on the display unit 154 and/or outputting sound via a sound output device, such as a speaker. It is understood that the control unit 130 may also inform the user that the document corresponding to the identification information is completely stored in the memory unit 120, is partially stored in the memory unit 120, etc.

If the scanned identification information of the document is not stored in the memory unit 120, the control unit 130 allows the user to select whether the document data corresponding to the scanned identification information of the document should be stored when the document is printed. That is, the user selects a document storage command through the buttons of the input unit 152.

If the document storage command to store the data at the time of printing the document is selected, the scan unit 110 scans the document data (document information, page numbers, and so on). Then, the control unit 130 stores the scanned document data in the memory unit 120, such that the stored data can be extracted and printed when the same document data is desired to be printed later.

In more detail, when the user wants to print the book “Pride and Prejudice,” the ISBN barcode attached to the front side or the rear side of the book “Pride and Prejudice” is scanned by the scan unit 110. The control unit 130 checks whether the scanned ISBN barcode information, that is, the identification information of the document, is stored in the memory unit 120, and informs the user through the display unit 154 that the document data corresponding to the scanned identification information is not stored in the memory unit 120 if the scanned identification information is not stored in the memory unit 120.

Thereafter, the control unit 130 allows the user to select whether the document data (the document information, the page numbers, etc.) of the book “Pride and Prejudice” should be stored when the book “Pride and Prejudice” is printed. If the user wants to store the document data, the user selects a button corresponding to the document storage command through the input unit 152. The document data is thereby stored in the memory unit 120 when the contents of the document are printed using the printing unit 140. At this time, the document data stored in the memory unit 120 includes information on the address of the memory unit 120 and configures the database such that the document data corresponding to the identification information can be easily searched later.

If, on the other hand, the user does not want to store the document data and does not select a button corresponding to the document storage command through the input unit 152, the contents of the document are printed using the printing unit 140. However, the document data is not stored in the memory unit 120.

Although the above description describes an example of a method of scanning the document data using the scan unit 110 and storing the document data in the memory unit 120, aspects of the present invention are not limited to the above-described method. For example, even when a device other than the scan unit 110 is used to read the document data, the same beneficial effects of the present invention are obtained.

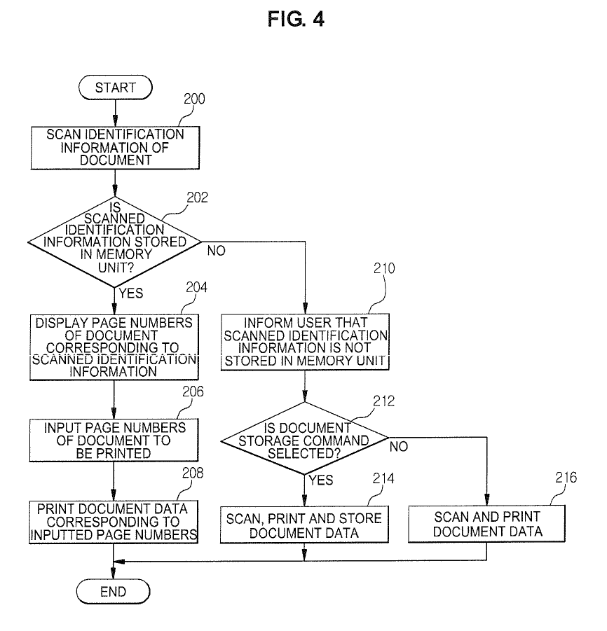

Hereinafter, a method of controlling the image forming apparatus 100 according to an embodiment of the present invention will be described. FIG. 4 is a flowchart illustrating the method of controlling the image forming apparatus 100 according to an embodiment of the present invention.

In FIG. 4, when the user wants to print a document (e.g., “Pride and Prejudice”), the identification information of the document to be printed (e.g., an ISBN barcode attached to the front side or the rear side of a book) is scanned by the scan unit 110 in order to check whether the document is stored in the memory unit 120 at operation 200. The control unit 130 determines whether the scanned ISBN barcode information, that is, the identification information of the document, is stored in the memory unit 120 at operation 202. If so, the control unit 130 extracts the document data corresponding to the identification information stored in the memory unit 120, that is, the scanned identification information, and displays the page numbers of the document on the display unit 154 as shown in FIG. 2 at operation 204.

Thereafter, when the user inputs the page numbers of the document to be printed within the page numbers displayed on the display unit 154 through the input unit 152 at operation 206), the control unit 130 extracts the document data corresponding to the inputted page numbers and prints the document information using the printing unit 140 at operation 208. Accordingly, the method of printing according to aspects of the present invention shortens a printing time, since the document data stored in the memory unit 120 is extracted and printed without the user having to separately perform the function to print the document.

If the control unit 130 determines that the scanned identification information is not stored in the memory unit 120 in operation 202, the control unit 130 informs the user that the document data corresponding to the scanned identification information is not stored in the memory unit 120 through the display unit 154 at operation 210. Thereafter, the control unit 130 allows the user to select whether the document data (the document information, the page numbers, etc.) should be stored when the document is printed at operation 212 and starts to configure the database using the identification information of the document scanned in operation 200 if the user selects the document storage command.

When the data of the document to be printed is scanned by the scan unit 110, the control unit 130 prints the scanned document data using the printing unit 140 and stores the document data in the memory unit 120 at operation 214. At this time, the document data stored in the memory unit 120 includes the information on the address of the memory unit 120 and the control unit 130 configures the database such that the data corresponding to the identification information of the document can be easily searched later. The data stored in the memory unit 120 allows the user to easily print the stored document data when the same document data is desired to be printed later.

If the control unit 130 determines that the user has not selected the document storage command in operation 212, then at operation 216 the control unit 130 scans the data of the document to be printed using the scan unit 110 and prints the scanned document data using the printing unit 140. However, the document data is not stored in the memory unit 120.

As described above, according to aspects of the present invention, an image forming apparatus checks whether document data to be printed is stored in a memory unit 120. If it is determined that the document data is stored in the memory unit 120, the stored document data is printed without a user having to separately input a printing command to print desired pages of a document. Accordingly, aspects of the present invention shorten a printing time. In addition, since identification information of the document to be printed is scanned, and an automatic checking operation is performed to determine whether the document is stored in the memory unit 120, the user may conveniently store and print document data to and from the memory unit 120.

When the document data is not stored in the memory unit 120, the user can store the document data in the memory unit 120. Accordingly, when the same document data is printed later, it is possible to easily print the document data and provide convenience to a later user.

Aspects of the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. For example, the control unit 130 may be embodied as computer readable code. The computer readable recording medium can also be distributed over network coupled computer systems so that the computer readable code is stored and executed in a distributed fashion. Also, functional programs, codes, and code segments for accomplishing aspects of the present invention can be easily construed by programmers skilled in the art to which the present invention pertains.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling an image forming apparatus, the method comprising:
scanning identification information of a document which identifies the document;
determining whether the scanned identification information of the document is stored in a memory unit; and
extracting document data corresponding to the identification information from the memory unit and printing the document data, according to whether the scanned identification information of the document is stored in the memory unit.

2. The method according to claim 1, wherein the identification information of the document is an international standard book number (ISBN) barcode of the document.

3. The method according to claim 1, wherein plural pieces of the identification information and the corresponding document data are stored in the memory unit.

4. The method according to claim 1, wherein the document data includes page numbers of the document.

5. The method according to claim 4, wherein the document data includes document information corresponding to the page numbers.

6. The method according to claim 4, further comprising inputting a desired page of the document in the page numbers of the document data,
wherein the printing of the document data comprises printing document information corresponding to the inputted page.

7. The method according to claim 1, further comprising indicating whether the scanned identification information of the document is stored in the memory unit.

8. The method according to claim 1, further comprising scanning the document data corresponding to the identification information and storing the document data in the memory unit if the scanned identification information of the document is not stored in the memory unit.

9. The method according to claim 8, wherein the storing of the document data comprises storing the document data when the document is printed according to whether a user inputs a document storage command.

10. An image forming apparatus comprising:
a memory unit to store identification information of a document and document data corresponding to the identification information;
a scan unit to scan identification information of a document to be printed;
a printing unit to print document data of the document to be printed; and
a control unit to determine whether the scanned identification information of the document is stored in the memory unit and to control the printing unit to extract and print the document data corresponding to the identification information stored in the memory unit according to whether the scanned identification information of the document to be printed corresponds to the identification information stored in the memory unit.

11. The image forming apparatus according to claim 10, wherein the document data of the document corresponding to the identification information stored in the memory unit comprises page numbers of the document and document information corresponding to the page numbers.

12. The image forming apparatus according to claim 10, wherein the control unit indicates whether the scanned identification information of the document is stored in the memory unit.

13. The image forming apparatus according to claim 10, wherein the control unit controls the scan unit to scan the document data of the document to be printed if the scanned identification information of the document is not stored in the memory unit and controls the memory unit to store the scanned document data of the document to be printed in the memory unit.

14. The image forming apparatus according to claim 10, wherein the identification information of the document is an international standard book number (ISBN) barcode of the document.

15. The image forming apparatus according to claim 10, wherein plural pieces of the identification information and the corresponding document data are stored in the memory unit.

16. The image forming apparatus according to claim 12, further comprising a display unit to display whether the scanned identification information of the document is stored in the memory unit.

17. The image forming apparatus according to claim 16, wherein the display unit comprises one of a liquid crystal display (LCD), a plasma display panel (PDP), a thin-film transistor (TFT) LCD, an organic electroluminescence display, or a cathode ray tube (CRT).

18. An image forming apparatus comprising:
a memory unit to store identification information of a document and document data corresponding to the identification information;
a printing unit to print the document data; and
a control unit to control the printing unit to print the document data stored in the memory unit according to whether identification information input to the control unit corresponds to the identification information stored in the memory unit.

19. The image forming apparatus of claim 18, further comprising a scan unit to input the identification information to the control unit.

20. The image forming apparatus of claim 19, wherein the identification information of the document is an international standard book number (ISBN) barcode of the document.

21. A computer readable medium having computer-executable instructions to perform the method comprising:
scanning identification information of a document which identifies the document;
determining whether the scanned identification information of the document is stored in a memory unit; and
extracting document data corresponding to the identification information from the memory unit and printing the document data, if the scanned identification information of the document is stored in the memory unit.
